(19) United States
(12) Patent Application Publication
(10) Pub. No.: US 2003/0172128 A1
(43) Pub. Date: Sep. 11, 2003

(54) Dynamic asynchronous results

(75) Inventors: Paul T. Bloomquist, El Dorado Hills, CA (US); John P. Hurlimann, Folsom, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/091,329

(22) Filed: Mar. 5, 2002

(51) Int. Cl. G06F 15/16

(52) U.S. Cl. 709/219

(57) ABSTRACT

A method, apparatus, and signal-bearing medium for providing results of an operation asynchronously to a verification that the operation was successfully submitted, providing status of objects as the status changes dynamically, and providing a history of the status. In an embodiment, a page downloaded from a server to a client may provide applications to monitor the status of objects referenced by the page.

### FIELD

An embodiment of the invention relates generally to a computer network and more particularly to reporting the results of an operation and status of an object in a network.

### BACKGROUND

People increasingly use networks of computers because they wish to access and share information. Some networks follow a client/server model, where a user at a client computer wishes to access information at a server and request operations to be performed at the server. Some clients download pages from servers and display them. These pages may include information and operations that the user may request. The client then sends the requested operations to the server for execution, which sends results back to the client, which may be in the form of another page.

Some operations take a long time to complete, and the user is concerned about the status of the operation. To address these concerns, some systems allow the user to manually refresh a page to show status of the operation. Other systems programmatically refresh a page. Still other systems require users to navigate to a separate page and query for the status of their operations.

Some information at a server may change over time. For example, a printer attached to a server may change states throughout the day, for example going between states of powered down, toner low, out of paper, paper jam, busy, and available. A user at a client may wish to know the current state of the printer and also what states it has been in the past. Some systems require the user to move to a separate application to query for state information.

### BRIEF DESCRIPTION OF THE DRAWINGS

FIG. 1 depicts a block diagram of a system for implementing an embodiment of the invention.

FIG. 2 depicts a block diagram of an example user interface for asynchronous results, according to an embodiment of the invention.

FIG. 3 depicts a flowchart of example processing for asynchronous results, according to an embodiment of the invention.

FIG. 4 depicts a block diagram of an example user interface for dynamic object status, according to an embodiment of the invention.

FIG. 5 depicts a flowchart of example processing for dynamic object status, according to an embodiment of the invention.

FIG. 6 depicts a block diagram of an example user interface for dynamic history scroll, according to an embodiment of the invention.

FIG. 7 depicts a flowchart of example processing for dynamic history scroll, according to an embodiment of the invention.

### DETAILED DESCRIPTION

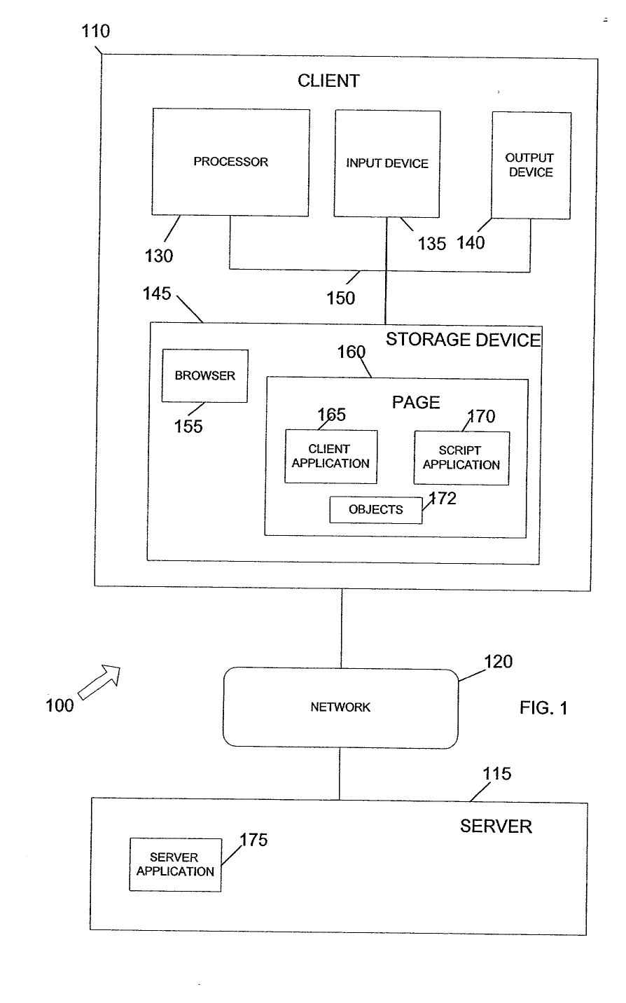

FIG. 1 depicts a block diagram of a system 100 for implementing an embodiment of the invention. The system 100 may include a client 110 connected to a server 115 via a network 120. The client 110 may include a processor 130, an input device 135, an output device 140, and a storage device 145, all connected via a bus 150.

The processor 130 may represent a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. The processor 130 may execute instructions and may include that portion of the client 110 that controls the operation of the entire electronic device. Although not depicted in FIG. 1, the processor 130 typically includes a control unit that organizes data and program storage in memory and transfers data and other information between the various parts of the client 110. In another embodiment, the processor 130 may not be present, and the client 110 may be implemented with hardware in lieu of a processor-based system.

The input device 135 may accept input from a user. In an embodiment, the input device 135 may be a keyboard, but in other embodiments, the input device 135 may be a pointing device, mouse, trackball, keypad, touch-pad, touch screen, pointing stick, microphone, or any other appropriate input device. Although only one input device 135 is shown, in other embodiments any number of input devices of the same or of a variety of types may be present.

The output device 140 may communicate information to the user of the client 110. The output device 140 may be a cathode-ray tube (CRT) based video display well known in the art of computer hardware. But, in other embodiments the output device 140 may be replaced with a liquid crystal display (LCD) based or gas, plasma-based, flat-panel display. In still other embodiments, any appropriate display device may be used. In yet other embodiments, a speaker that produces audio output may be used. Although only one output device 140 is shown, in other embodiments, any number of output devices of different types or of the same type may be present.

The storage device 145 may represent one or more mechanisms for storing data. For example, the storage device 145 may include read only memory (ROM), random access memory (RAM), magnetic disk storage media, optical storage media, flash memory devices, and/or other machine-readable media. In other embodiments, any appropriate type of storage device may be used. Although only one storage device 145 is shown, multiple storage devices and multiple types of storage devices may be present. Further, although the client 110 is drawn to contain the storage device 145, it may be distributed across other electronic devices.

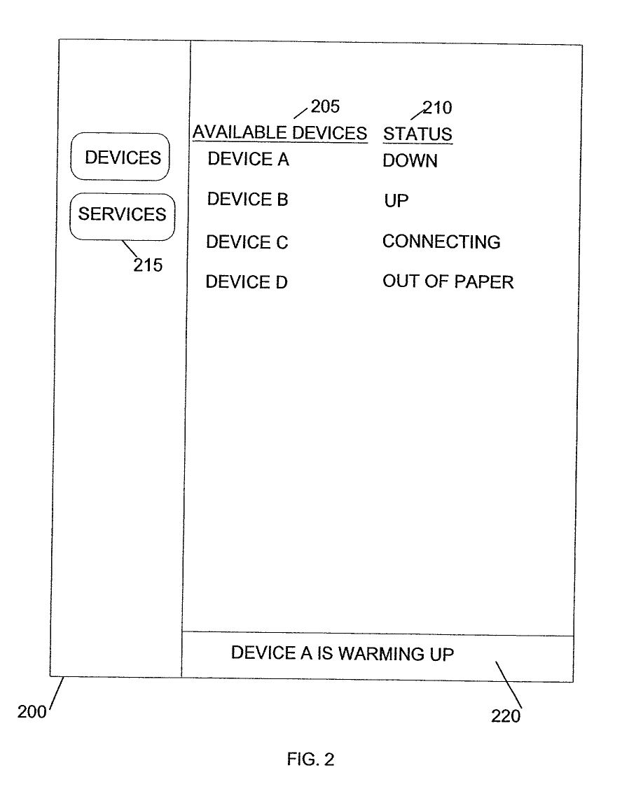

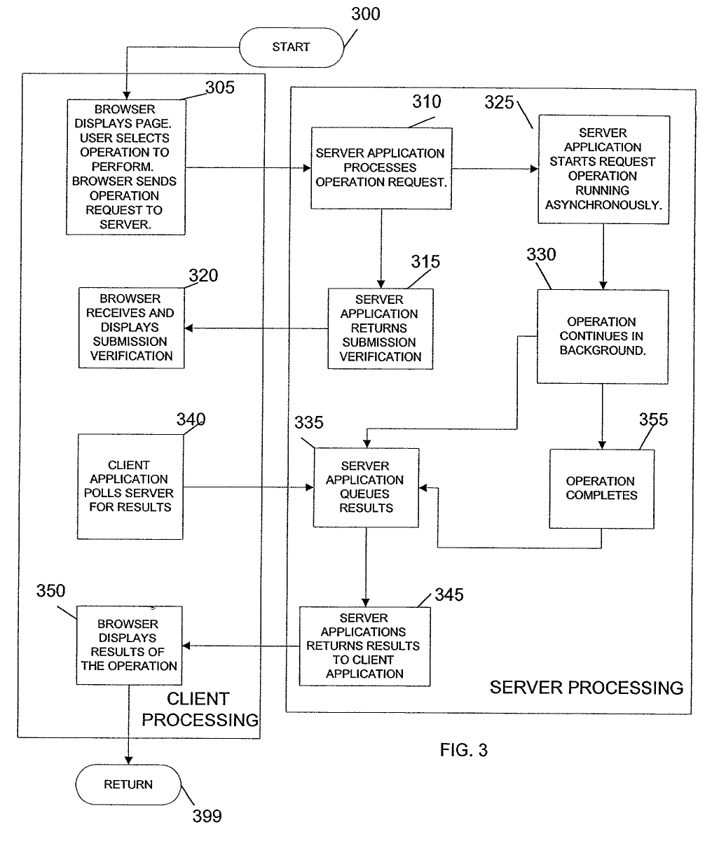

The storage device 145 may include a browser 155 and a downloaded page 160. Of course, the storage device 145 may also contain additional software and data (not shown), which are not necessary to understanding an embodiment of the invention. The client 110 may download the page 160 from the server 115, and the browser 155 may interpret data and control and/or formatting information within the page to display information on the output device 140. Examples of the displayed information are shown in FIGS. 2, 4, and 6, as further described below. The browser 155 may contain instructions for execution on the processor 130 to perform functions as further described below with reference to FIGS. 3, 5, and 7.

The page 160 may include a client application 165, a script application 170, and objects 172. In an embodiment the client application 165 may be an applet, although in other embodiments any appropriate application may be used. In an embodiment the script application 170 may be a Javascript application, but in other embodiments any appropriate application may be used. The objects 172 may have a status that is capable of being monitored and displayed as further described below with respect to FIGS. 2-7.

Although the client application 165, the script application 170, and the objects 172 are shown included or embedded within the page 160, in another embodiment one or more of them may be external to the page 160 and referenced-from or linked-to by the page 160. In an embodiment, the client application 165 and the script application 170 contain instructions for execution on the processor 130. In another embodiment, one or both of the client application 165 and the script application 170 may contain control information and data that are interpreted by the browser 155. The operations of the client application 165 and the script application 170 are further described below with reference to FIGS. 3, 5, and 7.

The bus 150 may represent one or more busses, e.g., PCI (Peripheral Component Interconnect), ISA (Industry Standard Architecture), X-Bus, EISA (Extended Industry Standard Architecture), or any other appropriate bus and/or bridge (also called a bus controller).

Although the client 110 is shown to contain only a single processor 130 and a single bus 150, another embodiment of the invention applies equally to electronic devices that may have multiple processors and to electronic devices that may have multiple buses with some or all performing different functions in different ways. Although only one client 110 is shown, in another embodiment any number of clients may be present.

The client 110 may be implemented using any suitable hardware and/or software, such as a personal computer or other appropriate electronic device. Portable electronic devices, laptop or notebook computers, PDAs (Personal Digital Assistants), two-way alphanumeric pagers, portable telephones, pocket computers, network appliances, minicomputers, and mainframe computers are examples of other possible configurations of the client 110.

The server 115 may include a server application 175. The operations of the server application 175 are further described below with reference to FIGS. 3, 5, and 7. The server 115 may be implemented using any suitable hardware and/or software, such as a personal computer or other appropriate electronic device. Portable electronic devices, laptop or notebook computers, minicomputers, and mainframe computers are examples of other possible configurations of the server 115. The server 115 may include a processor and memory (not shown), analogous to the processor 130 and the storage device 145. Although only one server 115 is shown, in another embodiment any number of servers may be present.

The network 120 may be any suitable network and may support any appropriate protocol suitable for communication between the client 110 and the server 115. In an embodiment, the network 120 may support wireless communications. In another embodiment, the network 120 may support hard-wired communications, such as a telephone line or cable. In another embodiment, the network 120 may support the Ethernet IEEE (Institute of Electrical and Electronics Engineers) 802.3x specification. In another embodiment, the network 120 may be the Internet and may support IP (Internet Protocol) RFC (Request for Comments) 791. In another embodiment, the network 120 may be a local area network (LAN) or a wide area network (WAN). In another embodiment, the network 120 may be a hotspot service provider network. In another embodiment, the network 120 may be an intranet. In another embodiment, the network 120 may be a GPRS (General Packet Radio Service) network. In another embodiment, the network 120 may be any appropriate cellular data network or cell-based radio network technology. In another embodiment, the network 120 may be an IEEE 802.11B wireless network. In still another embodiment, the network 120 may be any suitable network or combination of networks. Although one network 120 is shown, in other embodiments any number of networks (of the same or different types) may be present.

The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted.

As will be described in detail below, aspects of an embodiment pertain to specific apparatus and method elements implementable on an electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium (e.g., read-only memory devices attached to or within an electronic device, such as a CD-ROM readable by a CD-ROM drive);

(2) alterable information stored on a rewriteable storage medium (e.g., a hard disk drive or diskette); or

(3) information conveyed to an electronic device by a communications medium, such as through a network, including wireless communications.

Such signal-bearing media, when carrying machine-readable instructions that direct the functions of an embodiment of the present invention, represent embodiments of the present invention.

FIG. 2 depicts a block diagram of an example user interface 200 for asynchronous results, according to an embodiment of the invention. The user interface 200 is shown displayed on a display device, such as the output device 140. The browser 155 may download, read, and interpret the page 160 using the client application 165 to create the user interface 200 as further described below with reference to FIG. 3. The user interface 200 may include available devices 205, status 210, a services button 215, and a result frame 220. The user may select an operation via the services button 215, such as powering on a device in the available devices 205. The client 110 then sends a request, which identifies the selected operation, to the server 115. As the server 115 performs the operation, the client 110 displays the status of the operation in the result frame 220, which in this example is “Device A is warming up.” Although FIG. 2 illustrates the example of operations performed to devices, any appropriate objects and operations with respect to those objects may be used.

FIG. 3 depicts a flowchart of example processing for asynchronous results, according to an embodiment of the invention. Control begins at block 300. Control then continues to block 305 where the browser 155 reads, interprets, and displays the page 160 on the output device 140. The user selects an operation from the page 160 to perform, and the browser 155 sends the selected operation to the server 115. At block 310, the server application 175 receives the selected operation, verifies that the operation is valid, and builds a result page. At block 315, the server application 175 returns the result page to the client 110, indicating that the operation successfully started. At block 320, the browser 155 receives and displays the result page. At block 325, the server application 175 starts the requested operation running asynchronously to the returning of the result page previously described above with respect to block 315. At block 330, the operation continues running in a background thread or a separate process. At block 335, the server application 175 stores the progress of the operation in a result queue. At block 340, the browser 155 executes the client application 165 associated with the page, which may poll the server 115 for the available results of the operation. At block 345, the server application 175 may return the results to the client application 165 in response to the poll. In another embodiment, the server application 175 may return the results to the client application 165 via a push operation. At block 350, the browser 155 executes the client application 165 to display the results of the operation, for example by updating the content of the result frame 220. Blocks 330, 335, 340, 345, and 350 repeat to continually update the result frame 220. When the operation completes at block 355, blocks 335, 340, 345, and 350 are executed to display the final status in the result frame 220. Control then continues to block 399 where the function returns.

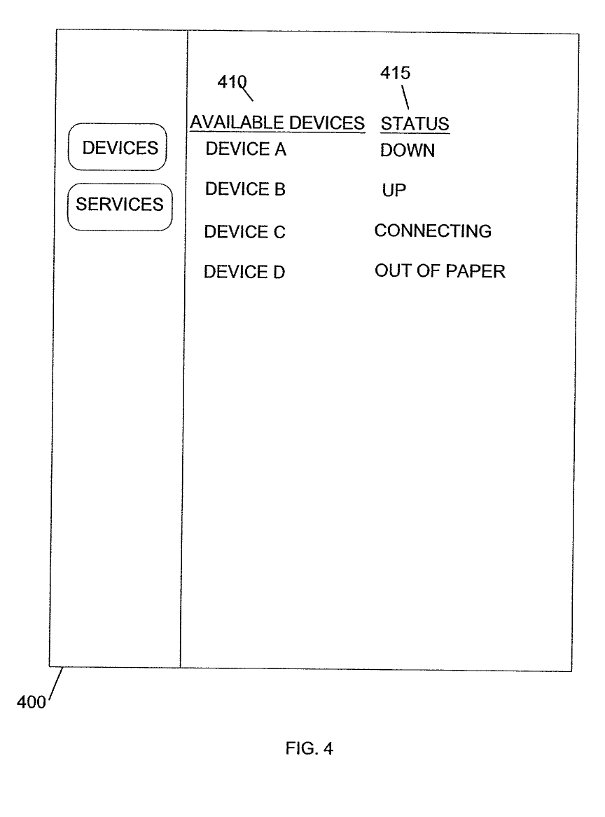

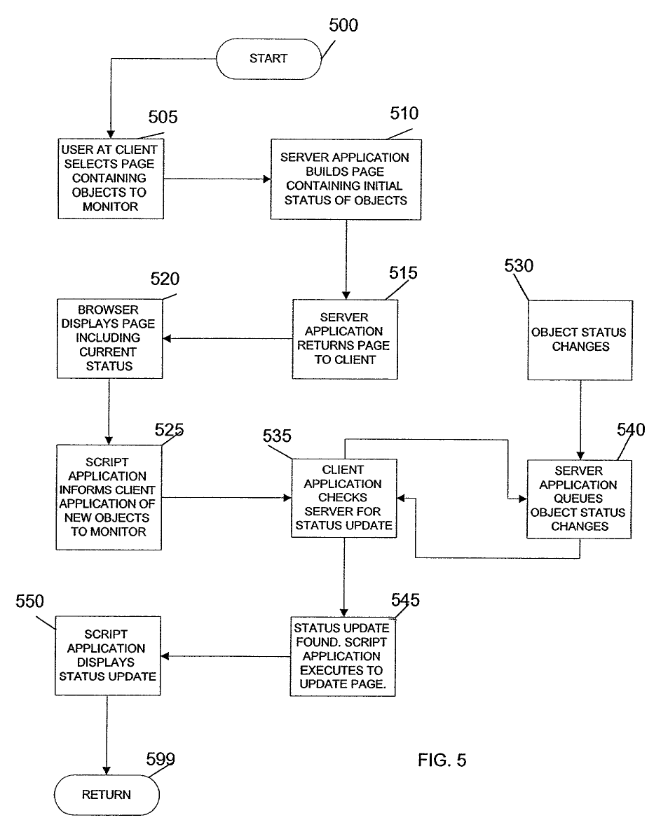

FIG. 4 depicts a block diagram of an example user interface 400 for dynamic object status, according to an embodiment of the invention. The user interface 400 is shown displayed on a display device, such as the output device 140. The browser 155 downloads, reads, and interprets the page 160 to create the user interface 400 as further described below with reference to FIG. 5.

The user interface 400 may include available devices 410 and status 415. As the status of the devices change, the status 415 of the devices is dynamically updated. Although FIG. 4 illustrates the example of the status of devices, any appropriate objects that have a status capable of being monitored may be used.

FIG. 5 depicts a flowchart of example processing for dynamic object status, according to an embodiment of the invention. Control begins at block 500. Control then continues to block 505 where the user selects a page containing objects to monitor, and the browser sends a request for the page to the server. Control then continues to block 510 where the server application 175 builds a page containing an initial status of the objects 172. Control then continues to block 515 where the server application 175 returns the page to the client 110. Control then continues to block 520 where the browser 155 reads, interprets, and displays the page 160 on the output device 140, including the current status of the monitored objects 172. Control then continues to block 525 where the browser 155 executes the script application 170, which informs the client application 165 of the objects 172 in the page 160 to monitor. Control then continues to block 535 where the client application 165 polls the server 115 for a status update. In another embodiment, a status update may be returned to the client application 165 via a push operation in lieu of a poll. When the object status changes at block 530, the object informs the server application 175, which queues the object status changes at block 540 and returns the status changes to the client application 165. At block 545, the client application 165 receives the status updates and looks up a method in the script application 170 to execute. At block 550, the appropriate method in the script application 170 displays the updated status of the object in the displayed page. Control then continues to block 599 where the function returns.

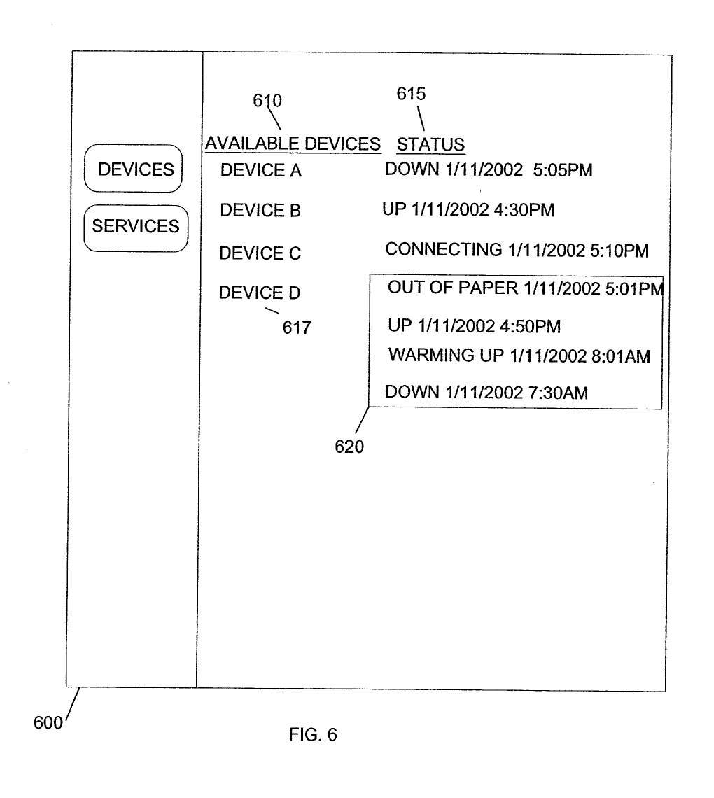

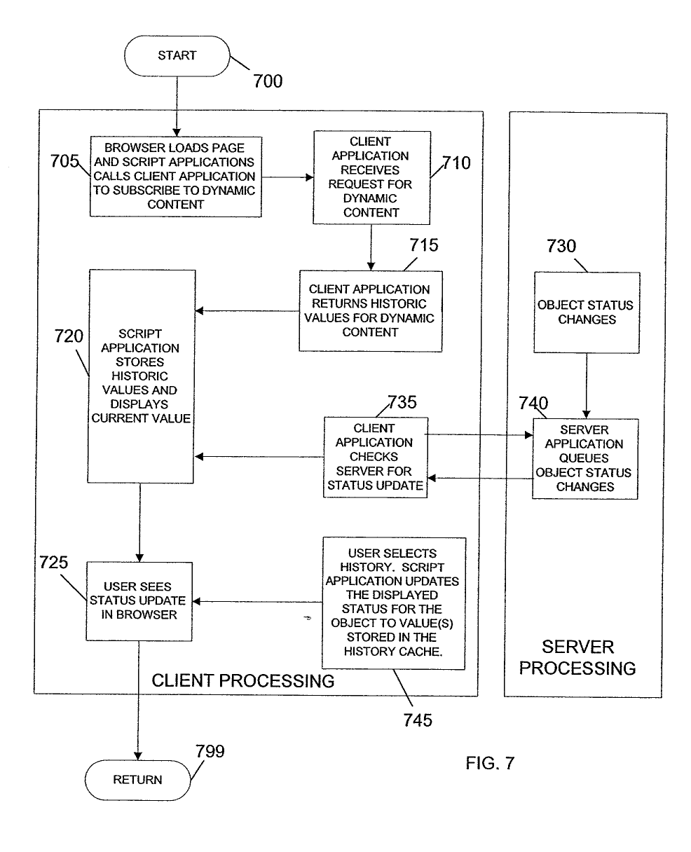

FIG. 6 depicts a block diagram of an example user interface 600 for dynamic history scroll, according to an embodiment of the invention. The user interface 600 is shown displayed on a display device, such as the output device 140. The browser 155 downloads, reads, and interprets the page 160 to create the user interface 600 as further described below with reference to FIG. 7.

User interface 600 may include available devices 610, status 615, and history 620. As the status of the devices change, the status 615 is dynamically updated. The user may select a history function, which shows the history 620 of the status for the selected device. In the example shown, Device D 617 has a status history of out of paper, up, warming up, and down. Although FIG. 6 illustrates the example of the status of devices, any appropriate objects that have a status that may change over time may be used.

FIG. 7 depicts a flowchart of example processing for a dynamic history scroll, according to an embodiment of the invention. Control begins at block 700. Control then continues to block 705 where the user selects a page 160 containing objects 172 to subscribe to for dynamic content. The browser 155 loads the page 160 and the script application 170, which informs the client application 165 of the objects 172 located on the page 160 and the script application method to run when the dynamic status of the objects 172 changes. Control then continues to block 710 where the client application 165 receives the request for dynamic content. Control then continues to block 715 where the client application 165 fetches the status history from a locally-stored cache, looks up methods to invoke to update the page with the current status, and invokes the methods for each object retrieved from the cache. Control then continues to block 720 where the script application 170 updates the displayed status for each object that has changed and stores the history values for future use. Control then continues to block 725 where the user sees the status update in the browser.

When the object status changes at block 730, the object informs the server application 175 that the status has changed, and the server application 175 queues the object status changes at block 740. At block 735, the client application 165 polls the server 115 for available status changes, and the server application 175 returns the queued status changes. In another embodiment, the server application 175 may return the status changes to the client application 165 via a push operation in lieu of a poll. Control then continues to blocks 720 and 725 as previously described above. When the user requests to see the history at block 745, the script application 170 updates the displayed status for the object to the value or values stored in the history cache. Control then continues to block 725 where the user sees the status updates. Control then continues to block 799 where the function returns.

In the previous detailed description of exemplary embodiments of the invention; reference was made to the accompanying drawings (where like numbers represent like elements), which form a part hereof, and in which was shown by way of illustration specific exemplary embodiments in which the invention may be practiced. These embodiments were described in sufficient detail to enable those skilled in the art to practice embodiments of the invention, but other embodiments may be utilized and logical, mechanical, electrical, and other changes may be made without departing from the scope of the present invention. The previous detailed description is, therefore, not to be taken in a limiting sense, and the scope of embodiments of the present invention is defined only by the appended claims.

Numerous specific details were set forth to provide a thorough understanding of embodiments of the invention. However, embodiments of the invention may be practiced without these specific details. In other instances, well-known circuits, structures and techniques have not been shown in detail in order not to obscure embodiments of the invention.

What is claimed is:

1. A method comprising:
sending a request for an operation selected from a page to a server, wherein the page is displayed by a browser interpreting data and control information in the page;
receiving a verification that the request for the operation was received;
executing an application identified by the page to poll the server for a result of the operation; and
receiving the result of the operation.

2. The method of claim 1, further comprising:
displaying the result of the operation in the page.

3. The method of claim 1, wherein executing the application further comprises:
interpreting the application to poll the server for the result of the operation, wherein the page comprises a link to the application.

4. The method of claim 1, wherein executing the application further comprises:
interpreting the application to poll the server for the result of the operation, wherein the application is embedded in the page.

5. A method comprising:
sending a page to a client, wherein the page comprises displayable data, formatting information, an identification of an operation, and an identification of a polling application;
receiving a request for the operation from the client;
sending a verification to the client that the request was received;
starting the operation executing;
queuing a result of the operation; and
returning the result to the client in response to a poll from the polling application.

6. The method of claim 5, wherein sending the page to the client further comprises:
embedding the polling application in the page.

7. The method of claim 5, wherein sending the page to the client further comprises:
adding a link to the polling application in the page.

8. The method of claim 5, where the starting the operation executing further comprises:
starting the operation executing asynchronously to sending the verification.

9. A signal-bearing medium bearing a page comprising:
an object;
a client application to poll a server for a status of the object; and
a script application to detect the object in the page, inform the client application of the object, and display the status.

10. The signal-bearing medium of claim 9, wherein the client application and the script application are interpreted by a browser.

11. The signal-bearing medium of claim 9, wherein the client application is further to receive the status from the server and find a method in the script application associated with the object to execute.

12. A server comprising:
a processor; and
memory coupled to the processor, wherein the memory comprises a server application to build a page comprising an object, control information, and an initial status of the object, send the page to a client, queue a change in the status, and send the change to the client.

13. The server of claim 12, wherein the server application is further to build the page comprising a client application to perform a poll and wherein the server application is to send the change to the client in response to the poll.

14. The server of claim 13, wherein the server application is further to build the page comprising a script application to find the object in the page and inform the client application of the object.

15. A signal-bearing medium bearing a page comprising:
an object;
a client application to fetch a history of status of the object; and
a script application to detect the object and inform the client application of the object.

16. The signal-bearing medium of claim 15 wherein the client application is further to poll a server for an update of the status.

17. The signal-bearing medium of claim 15, wherein the script application is further to store the history.

18. The signal-bearing medium of claim 17, wherein the script application is further to display the history.

19. The signal-bearing medium of claim 15, wherein the script application is further to inform the client application of a method to execute when the status changes.

20. The signal-bearing medium of claim 15, wherein the client application is further to subscribe to dynamic content of the object.
